(19) United States
(12) Patent Application Publication
(10) Pub. No.: US 2026/0260830 A1
(43) Pub. Date: Sep. 3, 2026

(54) HERMETICALLY SEALED HIGH VOLTAGE CONTACTOR WITH IMPROVED ARC QUENCHING

(71) Applicant: Rincon Power, LLC, Capinteria, CA (US)

(72) Inventors: Daniel Charles Sullivan, Santa Barbara, CA (US); Murray McTigue, Carpinteria, CA (US); Marius Avril, Santa Barbara, CA (US)

(73) Assignee: Rincon Power, LLC, Carpinteria, CA (US)

(21) Appl. No.: 19/543,372

(22) Filed: Feb. 18, 2026

Related U.S. Application Data
(60) Provisional application No. 63/761,687, filed on Feb. 21, 2025.

(51) Int. Cl. H01H 33/08; H01H 50/44; H01H 50/54

(52) U.S. Cl. CPC H01H 33/08; H01H 50/44; H01H 50/54

(57) ABSTRACT

A switching device comprising a first fixed contact, a second fixed contact, and a movable contact. The movable contact is mounted on a plunger configured to operate to change the state of the switching device from a closed state allowing current flow through the switching device to an open state which interrupts current flow through the switching device. The plunger is operable to move the movable contact between the open closed states in response to a magnetic field. The switching device further comprises a solenoid arranged to provide the magnetic field in response to an electrical signal. An arc chamber in included that housing the movable contact with arc chamber surfaces surrounding the moveable contact and having an arc suppressing material below the moveable contact.

### CROSS REFERENCE TO RELATED APPLICATION

This application claims the benefit of U.S. Provisional Patent Application Ser. No. 63/761,687, filed on February 21, 2025.

### BACKGROUND OF THE INVENTION

### Field of the Invention

The present invention relates to hermitically sealed electrical switching devices or contactors.

### Description of the Related Art

Hermetically sealed switching modules or contactors (“contactors”) are magnetically operated devices used for repeatedly establishing and interrupting an electrical power circuit and for switching of high electrical currents and/or high voltages. Direct current (DC) contactors can be used in many applications such as electric vehicles, solar systems, battery storage, industrial equipment and aerospace products. Many of these applications have a safety requirement where the contactor must “break" (or open under load) at a large amount of power once without rupturing. This requirement is usually called “max interrupt" One example of a max interrupt is breaking 1000 A at 1000V 1 cycle (i.e. 1Mwatt of power).

These types of contactors typically have fixed and movable internal contacts, and an internal actuating mechanism supported within a hermetically sealed housing. In some these contactors, once the moveable contact starts to separate from the stationary contacts an arc is formed between the two. Without adequate arc quenching, the arc can rapidly increase pressure in the sealed device, causing the device to rupture. One key to opening without rupture is to quickly quench the arc by cooling it.

In one type of contactor, air is removed from the contactor housing to create a vacuum that helps suppress arc formation, provides long operating life and allows for low resistance operation of the contactor. In another type of contactor, the evacuated chamber can be backfilled under pressure with an insulating gas, which allows the contactor to operate with improved arc-suppressing properties. For example, these types of contactors can be backfilled with nitrogen or hydrogen gas, or a combination of hydrogen/nitrogen gas, which can help absorb the energy of an arc and can play an important role in quenching the arc. Other approaches to suppressing these contactor arcs include incorporating internal magnets that stretch and cool the arc, and arranging the contacts such that there is a large contactor gap which aids in stretching and cooling the arc.

Referring now to FIG. 1, a conventional contactor 10 is shown that can have a material 12 on the arc chamber walls 14 and top surface 16, with the material capable of cooling the arc by absorbing arc energy. Different materials are used such as a ceramic including Alumina Oxide ceramic, with a thermal conductivity of 30W/m K. Other materials are also used having the same or similar thermal conductivity and some arrangements can also use materials such as glass filled nylon, with a thermal conductivity of only 0.22W/m-K.

U.S. Patent No. 4,168,480 to DeLucia discloses a high voltage magnetic contactor that is enclosed by an insulating housing containing a gas, such as sulfur hexafluoride, under pressure. The switch terminals removably extend through a wall of the housing and are sealed. The magnet contactor structure is removably connected to the housing by a sealed joint. A fill valve extends through a wall of the housing and is sealed to the housing. The armature shifts a pivotal arm in the housing between open and closed contact positions. The housing is formed of a polyamide material that is resistant to deterioration by fluorine gas, the material being poly hexamethylene terephthalic amide.

U.S. Patent No. 5,554,963 to Johler et al. discloses a contactor that includes a plastic enclosure, contacts disposed in the plastic enclosure for selectively operating to make and/or break at least one electrical connection, a gas filling containing at least one electronegative gas, and a sealed plastic encapsulation for preventing the at least one electronegative gas from diffusing away. The electronegative gases are not utilized at high pressure, but under atmospheric pressure or slightly higher pressure. Since normal pressure is used, a hermetically sealed encapsulation can be dispensed with and the enclosure can be made of low-cost plastics without connection to the outside air.

U.S. Patent No. 6,265,955 to Molyneux et al. generally discloses a contactor having a primary external sidewall formed by a plastic potting cup with a sealed chamber arranged within the cup and having the contactor’s moving components. The cup is enclosed at the bottom by a base, with the base and cup serving as a mold to hold epoxy material poured into the cup and cured to provide a hermetic seal. Insulated electrical leads extend through the epoxy material from the sealed chamber for connection of fixed and movable contacts to external circuitry. The base can have a threaded portion that extends from the underside of her cup.

### SUMMARY OF THE INVENTION

The present invention is directed to hermitically sealed switching modules or contactors (“contactors”) and their various components. Embodiments of the present invention provide improved contactors that can operate more reliably and can be provided in smaller sizes, all while maintaining or improving the operating characteristics over conventional contactors. Embodiments are directed to providing arc suppression materials around the contactor’s movable contact to improve suppression of arcs that can form between the fixed contacts and movable contact during contactor operation and can result in damage to the contactor.

One embodiment of an electrical switching device according to the present invention comprises a first fixed contact, a second fixed contact, and a movable contact. The movable contact is mounted on a plunger configured to operate to change the state of the switching device from a closed state allowing current flow through the switching device to an open state which interrupts current flow through the switching device. The plunger is operable to move the movable contact between the open closed states in response to a magnetic field. The switching device further comprises a solenoid arranged to provide the magnetic field in response to an electrical signal. An arc chamber in included that housing the movable contact with arc chamber surfaces surrounding the moveable contact and having an arc suppressing material below the moveable contact.

The systems according to the present invention can comprise many different features as described below. These and other aspects and advantages of the invention will become apparent from the following detailed description and the accompanying drawings which illustrate by way of example in the features of the invention.

### BRIEF DESCRIPTION OF THE DRAWINGS

FIG. 1 is a sectional view of a conventional contactor; and

FIG. 2 is a sectional view of one embodiment of a contactor according to the present invention in the open state.

FIG. 3 is a sectional view of another embodiment of a contactor according to the present invention in the open state.

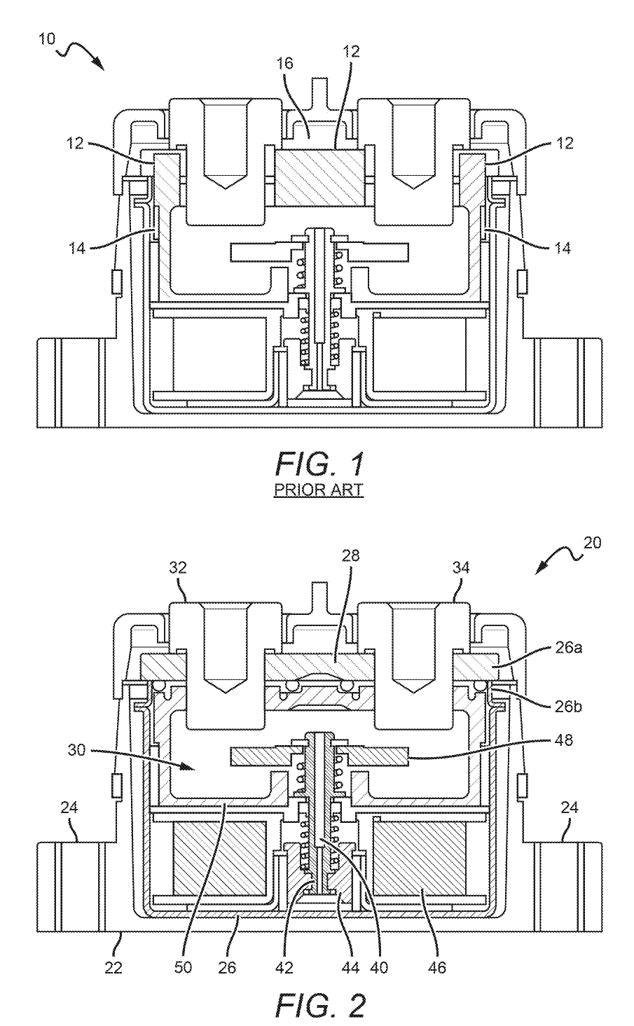

### DETAILED DESCRIPTION OF THE INVENTION

The present invention is directed to hermitically sealed contactors and in particular, improvements in the operation and reliability of such contactors. Internal arcs formed within contactors during operation can cause failure of the contactors. Contactors according to the present invention can improve operation and reliability by improved suppression and cooling of arcs within the contactors. In some embodiments, the internal surfaces of the contactors can comprise in increased coverage with arc suppression materials, with some embodiments of the present invention comprising increased coverage of the arc chamber with are suppressing materials like ceramics. In some embodiments, the arc suppressing material can surround most or all sides of the moveable contact with the coverage in some embodiments includes the bottom surface of the moveable contact.

This arrangement increases the surface area for the arc suppressing materials providing for increased thermal conductivity and improved energy absorption resulting in improved arc quenching performance. This improved design also surrounds the contact shaft and contact spring which protects the contact spring and shaft from copper ablation particles that eject when the arc erodes the contacts. Many different arc suppressing materials can be used, including but not limited to alumina nitride ceramic or alumina oxide ceramic.

The present invention is described herein with reference to certain embodiments, but it is understood that the invention can be embodied in many different forms and should not be construed as limited to the embodiments set forth herein. It is further understood that different embodiments can comprise different materials arranged in different ways, and can comprise different features. Different embodiments can also be arranged for mounting to other locations other than directly to a user.

It will be understood that when an element is referred to as being “on” or “connected to” another element, it can be directly on, or in contact with the other element or intervening elements may be present. In contrast, when an element is referred to as being “directly on”, or “directly connected to” another element, there are no intervening elements present. Although the terms first, second, etc. may be used herein to describe various elements, and/or sections, these elements and/or sections should not be limited by these terms. These terms are only used to distinguish one element, or section from another element, or section. Thus, a first element or section discussed herein could be termed a second element, or section without departing from the teachings of the present invention.

Embodiments of the invention are described herein with reference to perspective view illustrations that are schematic illustrations of an embodiment of the invention. As such, the actual thickness or size of components can be different, and variations from the shapes of the illustrations as a result, for example, of manufacturing techniques and/or tolerances are expected. Embodiments of the invention should not be construed as limited to the particular shapes as illustrated herein but are to include deviations in shapes that result, for example, from manufacturing. A region or element illustrated or described as being generally square or rectangular can have rounded or curved features due to normal manufacturing tolerances. Thus, the features illustrated in the figures are schematic in nature and their shapes are not intended to illustrate the precise shape of a feature of a device and are not intended to limit the scope of the invention.

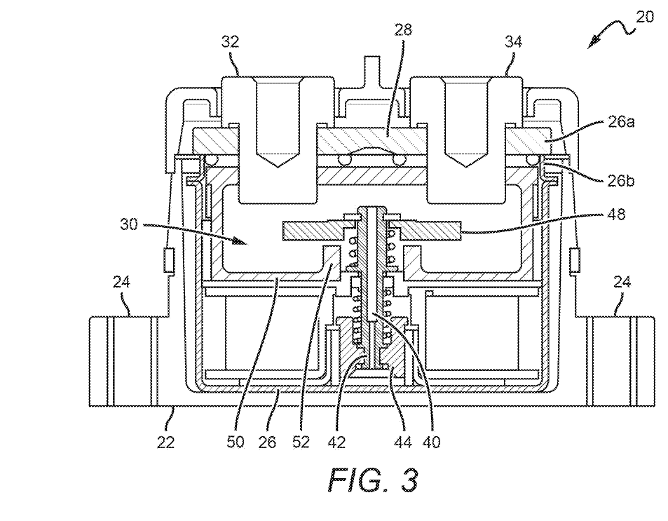

FIGS. 2 and 3 show one embodiment of a hermetically sealed contactor 20 according to the present invention that can comprise a cylindrical outer housing 22 for holding the contactor in the desired orientation and also comprises mounting points 24 for mounting the contactor in place for use using known mounting methods such as bolts or screws. The housing 22 can be made of many different materials such as low permeability plastic or polymer.

Contactor 20 further comprises a cup 26 that holds most of the contactors’ operational components and can be made of many different materials including but not limited to different metals. The contactor 20 further comprises a cap 28 that can be affixed to the opening of cup 26 to form a hermitically sealed chamber 30. Cap 28 can comprise many different materials including at least partially made of ceramic and metal components comprising a ceramic brazed assembly. The cap 26 can comprise a ceramic header 26a and brazing flange 26b around the edge of the ceramic header 26a that rests on and is brazed to the top of a second brazing flange 28a around the edge of the cup 26.

Contactor 20 can further comprise fixed contacts 32, 34 that can be configured such that the various internal components of the contactor 20 that are housed within the housing 26 can electrically communicate with an external electrical system or device. This communication allows the contactor 20 to function as a switch to break or complete an electrical circuit as described herein. The fixed contacts 32, 34 are shown as hermetic stationary contact feedthroughs mounted to a passing through a can 26. In some embodiments a hermetic weld can be included at the flanges around the contact 32, 34 and there is a hermetic seal between the fixed contacts 32, 34 and the cap 26 such that the contactor 20 maintains a hermetically sealed chamber 30.

The fixed contacts 32, 34 can comprise any suitable conductive material for providing electrical contact to the internal components of the contactor 20, and in some embodiments can comprise various metals and metallic materials or any electrical contact material or structure that is known in the art. The fixed contacts 32, 34 can comprise single continuous contact structures or can comprise multiple electrically connected structures.

The hermetically sealed contactor 20 further comprises a plunger 40 comprising a plunger shaft 42, and the plunger magnetic portion 44 that reacts to and is operable by the magnetic field. The contactor can comprise different mechanisms to provide an internal magnetic field to cause movement of the plunger, with the embodiment shows having a coil assembly or solenoid 46 to produce a magnetic field in response to an electrical signal produced by the coil assembly to cause movement of the plunger 40.

A movable contact 48 is mounted to the upper end of the plunger shaft and is movable with movement of the plunger shaft 42 in response to a magnetic field. In the open position as shown, there is a space between the fixed contacts 32, 34 such that an electrical signal cannot flow between the fixed contacts 32, 34 through the movable contact 48. The plunger shaft 42 can move towards the fixed contacts 32. 34 in response to a magnetic field to move the movable contact 48 into contact with the fixed contacts 32, 34 to provide a conductive path/bridge to allow electrical signals to pass between the fixed contacts 32, 34 through the movable contact 48.

The contactor 20 can further comprise an evacuation tube (not shown) that provides an opening to the hermetically sealed chamber during manufacturing, and is configured to allow for the creation of a vacuum and the introduction of a gas to the hermitically sealed chamber 30. Introduction of the gas and creation of the vacuum to the desired level is created manufacturing and the evacuation tube is closed for operation.

This hermetically sealed configuration with a vacuum and gas can help mitigate or prevent electrical arcing between adjacent conductive elements, and in some embodiments, helps provide electrical isolation between spatially separated contacts. In some embodiments, the core 22 can be at least partially filled with gas such as an electronegative gas, this can include for example, sulfur nitrogen, hydrogen, or a combination thereof, or hexafluoride or mixture of nitrogen and sulfur hexafluoride. The cup 26 and cap 28 can comprise a material having low or substantially no permeability to the gas. In other embodiments, the core can comprise various gases, liquids or solids configured to increase performance of the device.

During operation, the contactor 10 can be operable between open condition when the movable contact 48 is not in contact with the stationary contact 32, 34, and a closed condition when the movable contact 48 is in contact with the stationary contacts 32, 34. As discussed above, when in the open condition the fixed contacts 32, 34 are not interacting with any of the other components internal to the core 10 and the fixed contacts 32, 34 are otherwise electrically isolated from one another such that electricity cannot freely flow between the two.

When the contactor 20 is in the closed condition as shown both of the otherwise electrically isolated fixed contacts 32, 34 are contacted by moveable contact 30. The moveable contact 48 functions as a conductive bridge allowing an electrical signal to flow through the device, for example, from the first fixed contact 32, to the moveable contact 48, and to the second contact 34 or vice versa. Therefore, the contactor 10 can be connected to an electrical circuit, system or device and can complete a circuit while the moveable contact 48 is in electrical contact with the fixed contacts 32, 34.

The moveable contact 48 can comprise any suitable conductive material including any of the materials discussed herein in regard to the fixed contacts 32, 34. Like with the fixed contacts 32, 34, the moveable contact 30 can comprise a single continuous structure (as shown), or can comprise multiple component parts electrically connected to one another so as to serve as a contact bridge between the otherwise electrically isolated fixed contacts 32, 34 , so that electricity can flow through the contactor 10.

The moveable contact 48 can be configured such that it can move into and out of electrical contact with the fixed contacts 32, 34. This causes the circuit to be “closed” or completed when the moveable contact is in electrical contact with the fixed contacts 32, 34, and to be “open” or broken when the moveable contact 48 is not in electrical contact with the fixed contacts 32, 34.

Movement of the plunger 42 controls movement of the moveable contact 48, which in turn controls the position of the moveable contact 48 in relation to the fixed contacts 32, 34. This in turn controls flow of electricity through the contactor 10 as described herein. Movement of the plunger shaft 42 can be controlled through various configurations, including, but not limited to, electrical and electronic, magnetic and solenoid, and manual.

In the embodiment of the contactor 10 shown, movement of the plunger shaft 42 is controlled through the use of a coil or solenoid configuration. As mentioned above, the plunger’s magnetic portion 44 is at the base of the plunger shaft 42 and is connected to, and at least partially surrounds, a portion of the base of the plunger shaft 42. Magnetic portion 44 is made of a material that is movable under a magnetic field such as that produced by a conductive coil or solenoid. Causing movement of the magnetic portion 44 under a magnetic field causes corresponding movement of the plunger shaft 42 and thereby movement of the moveable contact 48.

During movement of the movable contact 48 from the closed position in contact with the fixed contacts 32, 34and the open position where there is separation between the movable contact 48 and fixed contacts 32, 34 arcs can form between the fixed contacts 32, 34 and the movable contact 48. As discussed above, these arcs can reduce reliability of the contacts by causing a pressure rupture. The hermetically sealed chamber 30 also serves as an arc chamber within which these arcs can form. The chamber 30 and be divided between the upper arc chamber 32a that is above the movable contact 48 when it is in the open position, and the lower arc chamber 32b that is below the movable contact 48. An arc suppressing material can be on the walls of chamber 30.

The embodiments of the present invention have materials on the surfaces of the chamber 30 arranged to help suppress arcs within the chamber or the arc chamber 30 can be at least partially be made of materials that help suppress arcs. In some embodiments, the arc chamber 30 can entirely made of materials to help suppress arcs. These are suppressing materials can include ceramic materials as discussed above, and in conventional contactors this material was provided on the surfaces of the upper arc chamber 32a and the surfaces above the movable contact 48 and the walls to the side of the moveable contact 48. It was previously believed that this would provide the necessary coverage to interact with and sufficiently suppress the arcs between the fixed contacts 32, 34 and moveable contact. However, according to the present invention, it was discovered that covering chamber surfaces in the chamber below the moveable contact 48 can improve arc suppression.

Accordingly, the embodiments of the present invention are directed to increasing the arc suppression material to cover the surfaces below the movable contact. Referring now to FIG. 2, the arc suppression material is on the bottom surface 50 of the chamber 30 below the movable contact 48 and in the embodiment shown, it is on the surface facing the bottom surface of the movable contact 48. FIG. 3 shows another embodiment of a contactor according to the present invention where the arc suppression material extends up the plunger wall 52, which can provide for further improvements in arc suppression. This embodiment provides the additional advantage of surrounding the plunger shaft 42 and contact spring 56, to protect both from copper ablation particles that eject when arcs erode the contacts. It is understood that in different embodiments of the present invention, the arc suppression material can cover different portions of the surfaces below the moveable contact.

The arc chambers according to the present invention can be manufactured in many different ways such as with injection molding, with some embodiments utilizing an arc chamber can be covered with or made of Aluminum Nitride ceramic (AIN), which can have a thermal conductivity of 160-225 W/m-K. Another material that can be utilized for low volume manufacturing is Aluminum Nitride-Boron Nitride (AlN-BN), which can be manufactured using known machining processes and has a thermal conductivity of 80W/m-K. It is understood that other materials can also be used that have the same or similar characteristics. Many other materials can be used and other embodiments can utilize arc chamber material that is electrically isolating with a thermal conductivity greater than 30W/mk. In other embodiments, the materials can be electrically isolating and have a conductivity greater that 40W/mK and in still other embodiments can have conductivity greater the 50W/mK.

The increased surface area of the arc suppressing material below the bottom of the movable contact can substantially improve thermal conductivity and improves the ability of the arc chamber to absorbed energy from the arc. This results in significantly improved arc quenching performance over typical design commercially available today. These improvements arc suppression provided by the pressing inventions can allow for much smaller and lightweight products with increased interruption performance due to the improved arc quenching.

It is understood that many different mechanisms and arrangements can be used in these different devices according to the present invention. Although the present invention has been described in detail with reference to certain configurations thereof, other versions are possible. Therefore, the spirit and scope of the invention should not be limited to the versions described above.

We claim:

1. An electrical switching device, comprising:
a first fixed contact, a second fixed contact, and a movable contact mounted on a plunger configured to operate to change the state of said switching device from a closed state allowing current flow through said switching device to an open state which interrupts current flow through said switching device;
wherein said plunger is operable to move said movable contact between said open state and said closed state in response to a magnetic field;
a solenoid arranged to provide said magnetic field in response to an electrical signal; and
an arc chamber housing said movable contact with arc chamber surfaces surrounding said moveable contact and having an arc suppressing material below the bottom surface of said moveable contact.

2. The switching device of claim 1, wherein said arc chamber further comprises arc suppressing material above said movable contact.

3. The switching device of claim 1, wherein said arc chamber further comprises arc suppressing material to the sides of said movable contact.

4. The switching device of claim 1, wherein said arc chamber further comprises arc suppressing material all surfaces surrounding said movable contact.

5. The switching device of claim 1, wherein said arc suppressing material comprises a ceramic.

6. The switching device of claim 1, wherein said arc suppressing material comprises Aluminum Nitride or Aluminum Nitride – Boron Nitride.

7. The switching device of claim 1, wherein said arc suppressing material is electrically isolating.

8. The switching device of claim 1, wherein said arc suppressing material has a thermal conductivity greater than 30W/mk.

9. The device of claim 1, further wherein said plunger comprises a plunger shaft, wherein said moveable contact is mounted near one end of said plunger shaft, and the other end of said plunger reacting to said magnetic field to move said movable contact.

10. An electrical switching device, comprising:
a hermitically sealed arc chamber;
first and second fixed contacts, each having a conductive path into said hermetically sealed arc chamber;
a movable contact movable in said hermetically sealed arc chamber between closed state in contact with said first and second fixed contacts and open state where said movable contact is not in contact with said first and second fixed contacts;
wherein said hermetically sealed arc chamber comprises internal surfaces surrounding said movable contact and further comprises an arc suppression material on one or more surfaces below said movable contact.

11. The switching device of claim 10, wherein said arc chamber further comprises arc suppressing material above said movable contact.

12. The switching device of claim 10, wherein said arc chamber further comprises arc suppressing material to the sides of said movable contact.

13. The switching device of claim 10, wherein said arc chamber further comprises arc suppressing material all surfaces surrounding said movable contact.

14. The switching device of claim 10, wherein said arc suppressing material comprises a ceramic.

15. The switching device of claim 10, wherein said arc suppressing material comprises Aluminum Nitride or Aluminum Nitride – Boron Nitride.

16. The switching device of claim 10, wherein said arc suppressing material is electrically isolating and has a thermal conductivity greater than 30W/mk.

17. The switching device of claim 10, wherein said hermetically sealed arc chamber is backfilled with gas.

18. An electrical switching device, comprising:
a hermitically sealed housing comprising a cup and cap hermetically sealed to said cap;
first and second fixed contacts mounted to said cap and each providing a conductive path from outside to inside said hermitically sealed housing;
a movable plunger and a movable contact mounted on said movable plunger, said device configured to operate to change the state of said switching device from a closed state allowing current flow through said switching device to an open state which interrupts current flow through said switching device; and
arc suppressing material in said hermitically sealed housing and arranged below said movable contact, said arc suppressing material capable of suppressing arcs formed between said first or second fixed contact and said movable contact.

19. The switching device of claim 18, wherein said arc chamber further comprises arc suppressing material above said movable contact.

20. The switching device of claim 18, wherein said arc chamber further comprises arc suppressing material to the sides of said movable contact.
